(19) United States
(12) Patent Application Publication
(10) Pub. No.: US 2017/0086491 A1
(43) Pub. Date: Mar. 30, 2017

(54) ROASTING MACHINE

(71) Applicant: BAHUTONG ENTERPRISE LIMITED COMPANY, Taiching City (TW)

(72) Inventors: CHUNG-CHIN HUANG, Taichung City (TW); CHIN-YING HUANG, Taichung City (TW); HSIN-MING HUANG, Taichung City (TW); HSING-HSIUNG HUANG, Taichung City (TW); YEN-JEN YEH, Taichung City (TW); YU-CHIN TSAI, Taichung City (TW); WEI-LONG CHEN, Taichung City (TW)

(21) Appl. No.: 14/866,527

(22) Filed: Sep. 25, 2015

(51) Int. Cl. A23N 12/08

(52) U.S. Cl. CPC A23N 12/08

(57) ABSTRACT

A roasting machine is provided, including a base, a heating device, a body, and a flow guiding device. The heating device is received inside the base to generate a hot air flow. The main body is provided on the base, and has a roasting room and a flow passageway, wherein the flow passageway communicates with the heating device. The flow guiding device includes a first diversion block and a plurality of guide vanes, wherein the first diversion block is received inside the roasting room; the guide vanes are received inside the flow passageway and under the first diversion block. Each of the guide vanes is inclined, and the guide vanes surround around an axis which passes through the center of the first diversion block. Whereby, the flow guiding device is capable of changing the flowing direction of the hot air flow to effectively stir the ingredients in the roasting room.

### BACKGROUND OF THE INVENTION

1. Technical Field

The present invention relates generally to a roasting device, and more particularly to a roasting machine which generates a hot air flow to roast ingredients.

2. Description of Related Art

As shown in FIG. 1, a conventional roasting machine 1 which is provided to roast granular ingredients, such as coffee beans and peanuts, includes a base 10, a heating device 12, and a main body 14. The heating device 12 is provided in the base 10 to heat the air for generating a hot air flow. The main body 14 is provided on the base 10, and has a roasting room 142 which communicates with the heating device 12. In addition, a grill 16 is received inside the roasting room 142 to hold the ingredients.

In the process of roasting ingredients, the hot air flow generated by the heating device 12 arises and flows into the roasting room 142. Whereby, the hot air flow flows through the intervals among the ingredients to roast the ingredients. However, the abovementioned hot air flow flowing into the roasting room is an upward current which has specific flowing direction. In this way, the hot air flow is incapable of stirring the ingredients in the roasting room 142; as a result, the ingredients from the same batch may be unevenly roasted.

Therefore, the conventional roasting machine 1 still has room for improvement.

### BRIEF SUMMARY OF THE INVENTION

In view of the above, the primary objective of the present invention is to provide a roasting machine for roasting ingredients more evenly.

The present invention provides a roasting machine including a heating device, a main body, and a flow guiding device. The heating device generates a hot air flow. The main body has a roasting room and a flow passageway, wherein the flow passageway communicates the heating device and the roasting room. The flow guiding device includes a first diversion block and a plurality of guide vanes, wherein the first diversion block is received inside the roasting room, and has a first cone which is tapered off from a bottom to a top thereof. The guide vanes is received inside the flow passageway, and is provided under the first diversion block. The plurality of guide vanes surround an axis which passes through a center of the first cone, wherein each of the plurality of guide vanes is inclined.

Whereby, the flow guiding device changes the flowing direction of the hot air flow to effectively stir the ingredients in the roasting room, which makes the ingredients be roasted evenly.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of the conventional roasting machine;

FIG. 2 is a perspective view of a preferred embodiment of the present invention;

FIG. 3 is a exploded view of FIG. 2;

FIG. 4 is a sectional view along the 4-4 line in FIG. 2;

FIG. 5 is a partial exploded view of FIG. 2, showing the fixing seat and the guide vanes;

FIG. 6 is a partial expanded view of FIG. 5, showing the peripheral surface of the fixing seat;

FIG. 7 is a top view of the preferred embodiment, showing the stopper is above the guide vanes;

FIG. 8 is a partial enlarged view of FIG. 7; and

FIG. 9 is a schematic diagram of the preferred embodiment, showing the flowing direction of the hot air flow.

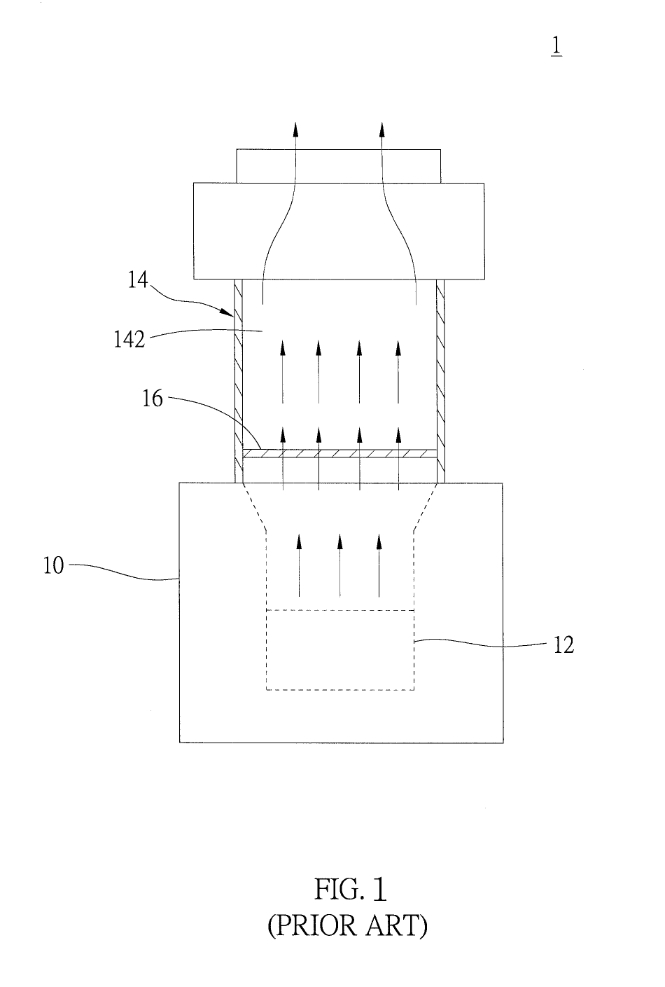

### DETAILED DESCRIPTION OF THE INVENTION

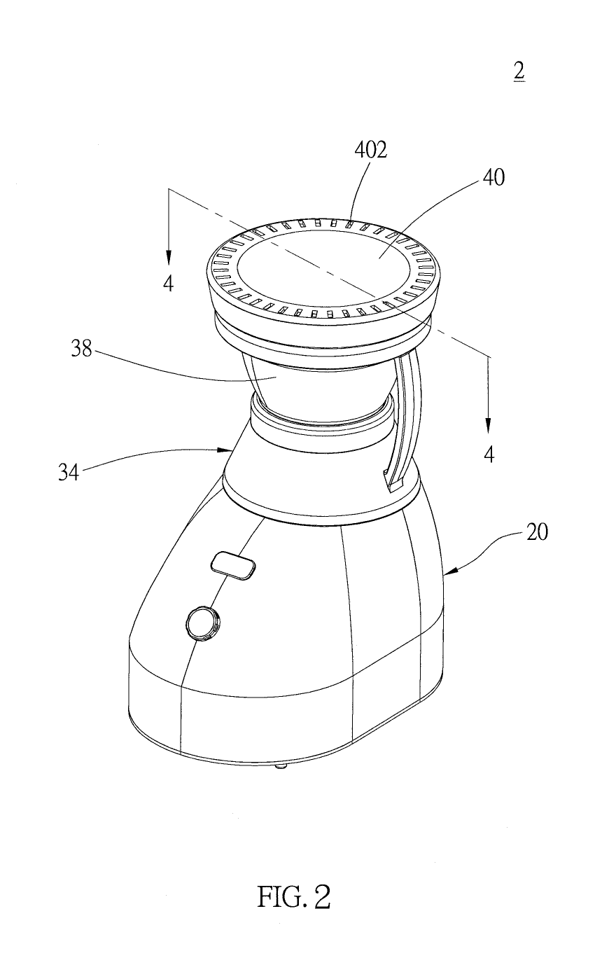

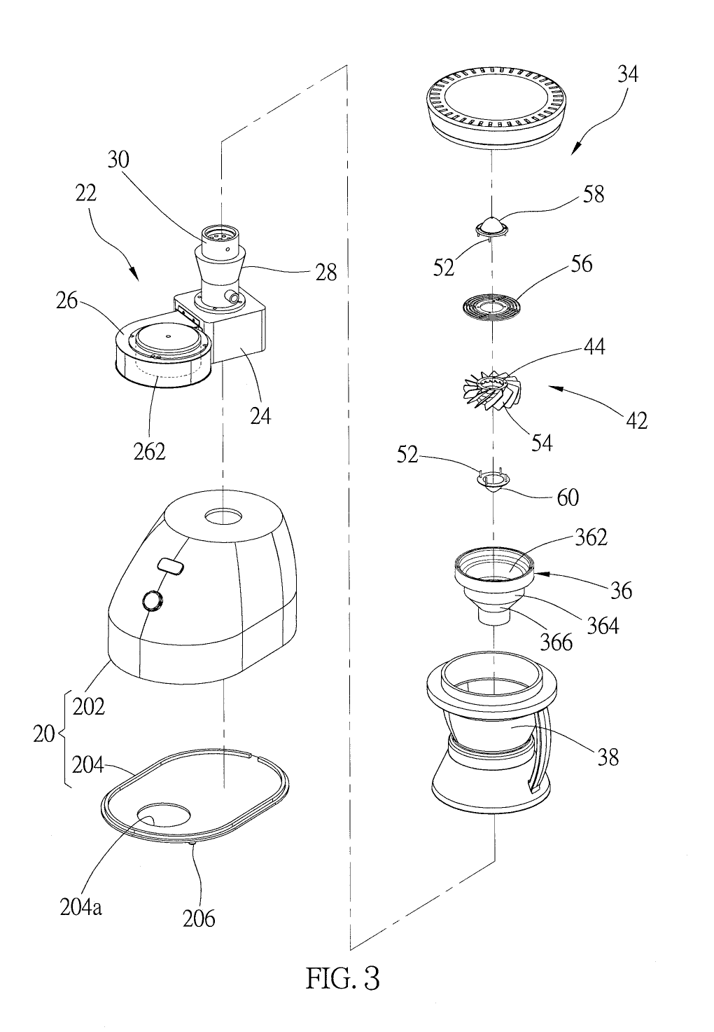

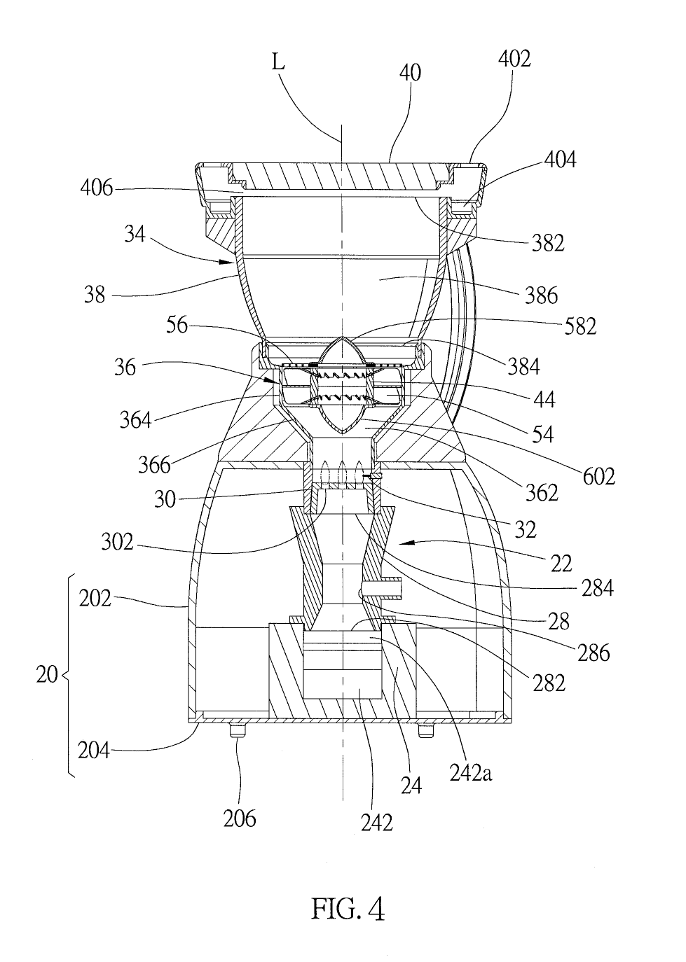

As shown in FIG. 2 to FIG. 4, a roasting machine 2 of the preferred embodiment of the present invention includes a base 20, a heating device 22, a main body 34, and a flow guiding device 42. Ingredients in the preferred embodiment includes coffee beans.

The base 20 includes a case 202, baseplate 204 and a plurality of supports 206, wherein the baseplate 204 is connected to the bottom of the case 202, and has an opening 204a. The plurality of supports are fixed on the bottom of the baseplate 204, as a result, when the base 20 is placed on a bearing surface, the opening 204a would not be covered by the bearing surface.

The heating device 22 is received inside the base 20, and includes a connecting seat 24, a blower 26, a mixing pipe 28, and a burner 30. The connecting seat 24 is located on the baseplate 204, and has a passageway 242 which forms an entrance (not shown) on a lateral of the connecting seat 24 and also an exit 242a on a top surface thereof. The blower 26 is connected to the lateral of the connecting seat 24 to correspond to the entrance, wherein the inlet 262 of the blower corresponds to the opening 204a on the baseplate 204. The mixing pipe 28 is vertically provided on the top surface of the connecting seat 24, and has an inlet 282, an outlet 284, and a side hole 286, wherein the inlet 282 and the outlet 284 are arranged at an axis. The inlet 282 joins the exit 242a of the connecting seat 24 to communicate with the blower 26. The side hole 286 is formed between the inlet 282 and the outlet 284, and passes through the wall of the mixing pipe 28 for gas input.

The burner 30 is connected to the outlet 284 of the mixing pipe 28. Additionally, the burner 30 has a plurality of flame holes 302, and further includes an igniter 32 provided near the plurality of flame holes 302. Whereby, when the blower 26 controllably guides the air to the outlet 284 of the mixing pipe 28, the gas input from the side hole 286 could be guided toward the outlet 284; moreover, the gas would be mixed with the air between the side hole 286 and the outlet 284, and subsequently be carried to the burner 30. Consequently, the gas is output from the flame holes 302, and then the igniter 32 burns the gas to generate an upward hot air flow.

The main body 34 includes a connecting pipe 36, a container 38, and a collector 40. The connecting pipe 36 is vertically provided on the burner 30, and has a flow passageway 362 therein for the hot air flow to pass through. In addition, the connecting pipe 36 includes a first section 364 and a second section 366, which are connected to each other. The second section 366 is provided between the burner 30 and the first section 364, wherein the second section 366 is a taper, of which the internal diameter is reduced downwardly, while the internal diameter of the first section 364 is consistent. Whereby, the interior of the first section 364 and the second section 366 respectively form a column section and a tapered section of the flow passageway 362. The container 38 has an upper opening 382, a bottom opening 384, and a roasting room 386 which is formed between the upper opening 382 and the bottom opening 384. The container 38 is connected to a top of the connecting pipe 36, and the bottom opening 384 accordingly corresponds to the first section 364.

The collector 40 is connected to a top of the container 38 to correspond to the upper opening 382, wherein the collector 40 has a plurality of outlets 402 at the top and a trough 404. In addition, a space 406 is formed between the collector 40 and the periphery of the upper opening 382, wherein the total areas of the outlets 402 is more than 1.1 times of the area of the space 406 to prevent a backpressure. Whereby, the hot air flow could be discharged from the outlets 402 smoothly.

The flow guiding device 42 includes a fixing seat 44, a plurality of guide vanes 54, a stopper 56, a first diversion block 58, and a second diversion block 60. The fixing seat 44 and the guide vanes 54 is received inside the first section 364 of the connecting pipe 36,wherein the fixing seat 44 is tubular and has a plurality of slots 442 thereon; each of the guide vanes 54 is detachably inserted into one of the slots 442.

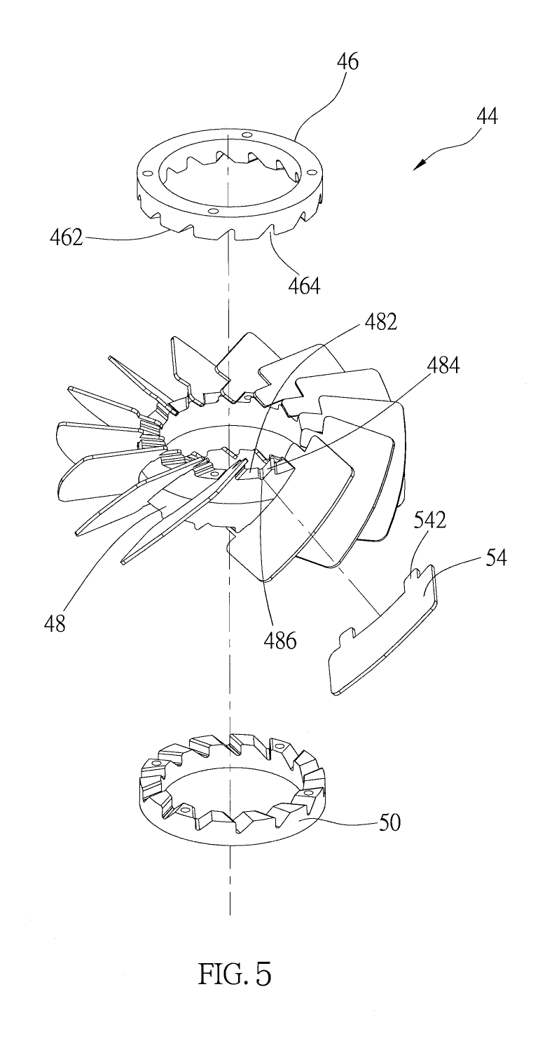

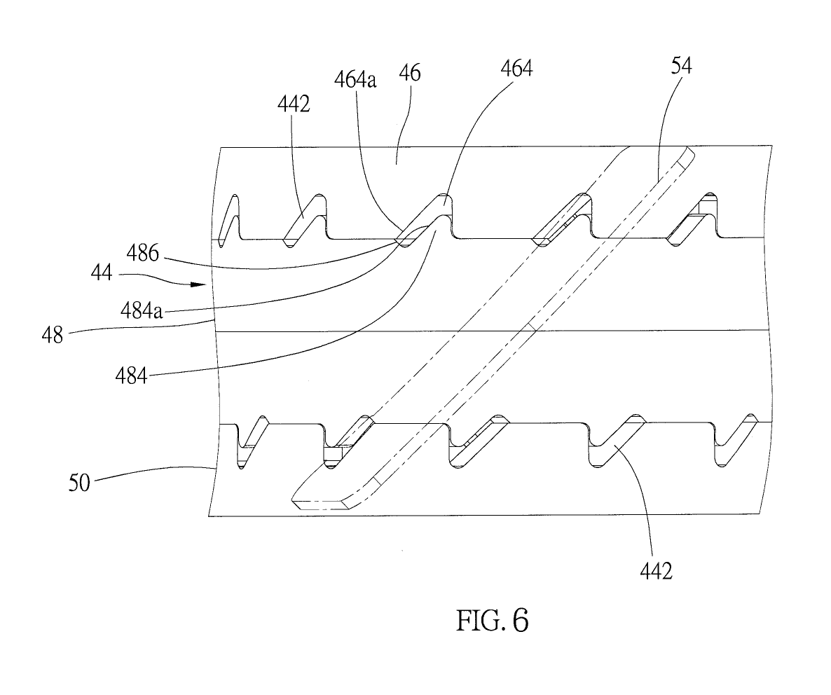

As shown in FIG. 5 and FIG. 6, in the preferred embodiment, the fixing seat 44 includes a first seat 46, a second seat 48, and a third seat 50, which are stacked and arranged downwardly, wherein the two adjacent seats are detachable connected by bolts 52. The structure of the first seat 46 is identical to that of the third seat 50; similarly, the second seat 48 is divided into an upper half and a lower half, of which the structures are the same. Therefore, to simply clarify the structure of the fixing seat 44, the connection between the first seat 46 and the upper half of the second seat 48 is specified below.

The first seat 46 has a first end surface 462 facing the second seat 48, wherein a plurality of notches 464 are formed on the first end surface 462, which are arranged around the center of the first seat 46; additionally, each of the notches 464 has a slanting surface 464a. The second seat 48 has a second end surface 482 on a top, which faces the first seat 46, wherein the second end surface 482 forms a plurality of bumps 484, which fit in the notches 464. Each of the bumps 484 has a slanting surface 484a, which faces the slanting surface 464a of one of the notches 464, wherein a space is formed between the corresponding slanting surfaces 464a and 484a. In addition, the second end surface 482 further forms a plurality of grooves 486, wherein each of the grooves 486 is adjacent to the slanting surface 484a of one of the bumps 484, and communicates with one of the notches 464. Each of the space formed between the corresponding slanting surfaces 464a and 484a constitutes a section of one of the slots 442, while each of the grooves 486 constitutes another section.

The third seat 50 and the lower half of the second seat 48 are the inversion of the first seat 46 and the upper half of the second seat 48 respectively. Especially, two corresponding slots 442 of the upper half and the lower half of the fixing seat 44 are vertically dislocated and are arranged in an extension line.

Each of the guide vanes 54 has two inserts 542, which insert the two corresponding slots 442 respectively, and accordingly the guide vanes 54 are inclined. A part of each of the inserts 542 insets in one of the grooves 486 before the first seat 46 is connected to the second seat 48. In other words, the guide vanes 54 are connected to the second seat 48 in the first place to simplify the fabrication of the fixing seat 44. Next, the bolts 52 fix the first seat 46 to the second seat 48, which makes the inserts 542 abut against the slanting surface 464a of the notches 464 and the bumps 484 so as to secure the guide vanes 54.

Practically, the third seat 50 could be removed, and the number of the insert 542 of each of the guide vane 54 could be one. In this way, the guide vanes 54 could also be fixed between the first seat 46 and the second seat 48. Additionally, the grooves 486 could be removed, too. In such case, the first seat 46 is connected to the second seat 48 first for the inserts 542 to fit into the slots 442.

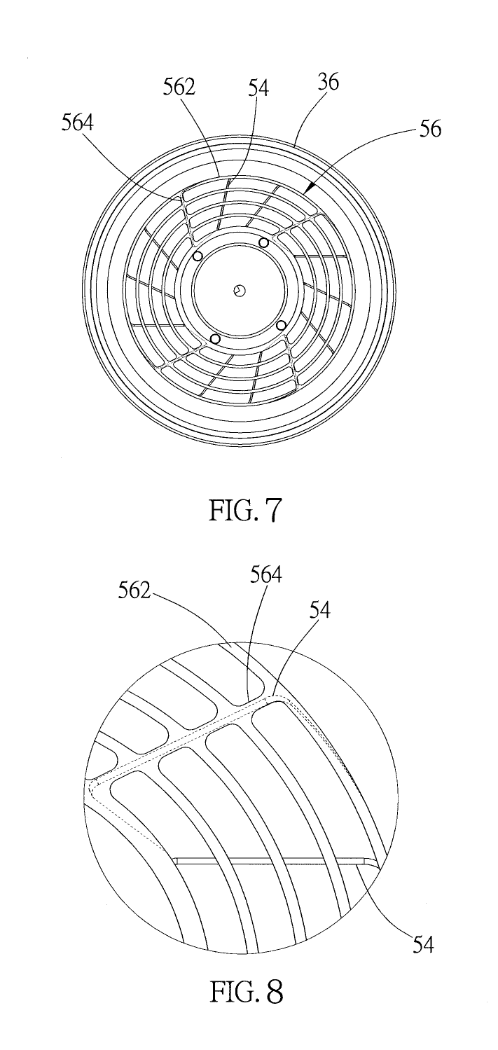

The stopper 56 is connected to the first seat 46 by the bolts 52, and is corresponded to the bottom opening 384 of the container 38. As shown in FIG. 7 and FIG. 8, the stopper 56 includes a plurality of concentric ring bodies 562 and ribs 564, wherein a distance is formed between the adjacent two ring bodies 562; each of the ribs 564 connects the ring bodies 562, and is arranged directly above one of the guide vanes 54. Whereby, the ribs 564 are capable of support the ring bodies 562 without blocking the hot air flow between two of the guide vanes 54. In another preferred embodiment, the space between the guide vanes 54 is smaller than a coffee bean to prevent the falling of the coffee beans; therefore, the stopper 56 could be removed.

The first diversion block 58 is fixed on the stopper 56 by the bolts 52, which makes the stopper 56 be provided between the guide vanes 54 and the first diversion block 58. The first diversion block 58 is received inside the roasting room 386, and has a first cone 582 which is tapered off from a bottom to a top. An axis vertically passing through a top point of the first cone 582 is defined as an axis L, wherein the guide vanes 54 surrounds the axis L. Moreover, the axis L passes through the center of the connecting pipe 36.

The second diversion block 60 is fixed to the third seat 50 of the fixing seat 44 by the bolts 52, and is received inside the second section 366 of the connecting pipe 36. In other words, the second diversion block 60 is received inside the flow passageway 362, and is provided under the guide vanes 54. Additionally, the second diversion block 60 has a second cone 602, which is tapered off from a top to a bottom. The center of the second cone 602 is arranged at the axis L; whereby, the second section 366 of the connecting pipe 36 surrounds the second cone 602 with an equal distance. Moreover, the second diversion block 60 and the first diversion block 58 are arranged in the orthogonal projection region of the fixing seat 44.

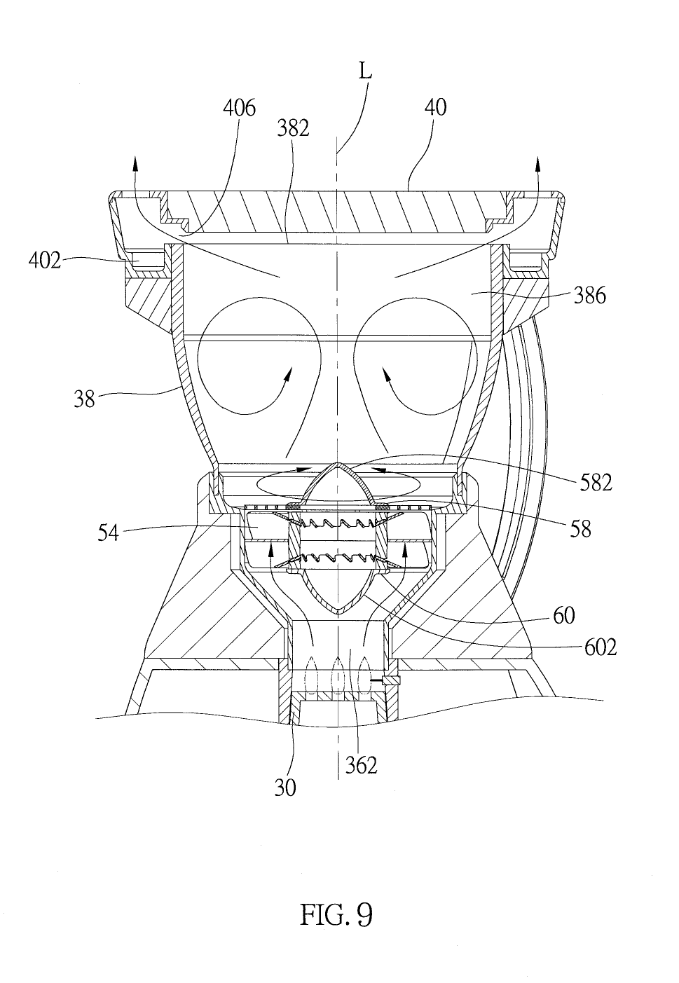

As shown in FIG. 9, the second cone 602 of the second diversion block 60 is provided at the center of the flow passageway 362, as a result, the hot air flow generated by the burner 30 would flow through the peripheral of the second cone 602 in equal amount. Whereby, the hot air flow could smoothly pass through the flow passageway 362 without forming a swirl, which increase the strength of the hot air flow flowing into the roasting room 386.

Furthermore, the hot air flow is guided by the guide vanes 54 when flowing among the guide vanes 54 to eddy round the axis L, which pushes the coffee beans in the roasting room 386 to move around the axis L.

Moreover, the stacking thickness of the coffee beans on the first cone 582 is smaller than that on the guide vanes 54. Therefore, the flow resistance directly above the first cone 582 is smaller in the roasting room 386, which makes the hot air flow flow upwards along the first cone 582 to flip the coffee beans from the center of the roasting room 386. A part of the hot air flow brings debris of the coffee beans into the collector 40 through the space 406, and finally into the collector 40.

In conclusion, the roasting machine 1 in the present invention makes the ingredients in the roasting room 386 be roasted evenly through the flow guiding device 42, wherein the thermal stir the ingredients through the designs of the current first diversion block 58 and the guide vanes 54. On the other hand, the hot air flow is strengthened due to the design of the second diversion block 60. In addition, the roasting machine 1 could be used for roasting other granular ingredients, such as peanuts and legumes.

It must be pointed out that the embodiments described above are only some preferred embodiments of the present invention. All equivalent structures which employ the concepts disclosed in this specification and the appended claims should fall within the scope of the present invention.

What is claimed is:

1. A roasting machine, comprising:
a heating device which generating a hot air flow;
a main body having a roasting room and a flow passageway, wherein the flow passageway communicates the heating device and the roasting room; and
a flow guiding device comprising a first diversion block and a plurality of guide vanes, wherein the first diversion block is received inside the roasting room, and has a first cone which is tapered off from a bottom to a top thereof; the guide vanes is received inside the flow passageway, and is provided under the first diversion block; the plurality of guide vanes surround an axis which passes through a center of the first cone, wherein each of the plurality of guide vanes is inclined.

2. The roasting machine of claim 1, further comprising a second diversion block which is received inside the flow passageway, and is provided under the plurality of guide vanes;
wherein the second diversion block has a second cone which is tapered off from a top to a bottom thereof; the center of the second cone is arranged at the axis.

3. The roasting machine of claim 2, wherein the flow passageway has a column section and a tapered section, which communicate with each other; the plurality of guide vanes are received inside the column section; the internal diameter of the tapered section is reduced downwardly, wherein the second diversion block is received inside the tapered section.

4. The roasting machine of claim 1, wherein the flow guiding device comprises a fixing seat which is detachably connected to the plurality of guide vanes.

5. The roasting machine of claim 4, wherein the fixing seat has a peripheral surface which forms a plurality of slots thereon; each of the plurality of guide vanes has an insert which inserts in one of the plurality of slots.

6. The roasting machine of claim 5, wherein the fixing seat comprises a first seat and a second seat which is detachably connected to the first seat; an end surface of the first seat forms a plurality of notches, while an end surface of the second seat forms a plurality of bumps, wherein each of the plurality of bumps fits into one of the plurality of notches; a space between each of the plurality of bumps and the corresponding notch forms one of the plurality of slots.

7. The roasting machine of claim 6, wherein the end surface of the second seat forms a plurality of grooves; each of the plurality of grooves communicates with one of the plurality of notches, and constitutes a section of one of the plurality of slots, while the space between each of the plurality of bumps and of the corresponding notch forms another section of one of the plurality of slots.

8. The roasting machine of claim 1, further comprising a stopper provided between the plurality of guide vanes and the first diversion block; the stopper comprises a plurality of concentric ring bodies and a plurality of ribs, wherein each two adjacent ring bodies are separated by a distance therebetween; each of the plurality of ribs connects the plurality of ring bodies, and is arranged directly above one of the plurality of guide vanes.

9. The roasting machine of claim 1, wherein the main body comprises a container and a collector; the container has the roasting room and an upper opening which communicates with the roasting room; the collector is connected to the container, and communicates with the upper opening, wherein the collector has a plurality of outlets; a space is formed between the collector and a periphery of the upper opening, wherein the total areas of the plurality of outlets is more than 1.1 times of the area of the space.

10. The roasting machine of claim 1, wherein the heating device comprises a mixing pipe, a blower, and a burner, wherein the mixing pipe has an inlet, an outlet, and a side hole; the inlet communicates with the blower, while the outlet communicates with the burner; the side hole is formed between the inlet and the outlet for gas input; the burner burns the gas to generate the hot air flow which flows into the flow passageway.
